(19) United States
(12) Patent Application Publication
(10) Pub. No.: US 2013/0114694 A1
(43) Pub. Date: May 9, 2013

(54) PARAMETER SET GROUPS FOR CODED VIDEO DATA

(71) Applicant: Qualcomm Incorporated, San Diego, CA (US)

(72) Inventors: Ying Chen, San Diego, CA (US); Ye-Kui Wang, San Diego, CA (US); Marta Karczewicz, San Diego, CA (US)

(73) Assignee: QUALCOMM INCORPORATED, San Diego, CA (US)

(21) Appl. No.: 13/669,595

(22) Filed: Nov. 6, 2012

Related U.S. Application Data
(60) Provisional application No. 61/557,380, filed on Nov. 8, 2011.
(60) Provisional application No. 61/584,626, filed on Jan. 9, 2012.
(60) Provisional application No. 61/590,702, filed on Jan. 25, 2012.

(51) Int. Cl. H04N 7/26

(52) U.S. Cl. 375/240.03; 375/240.02; 375/E07.126; 375/E07.139

(57) ABSTRACT

A video coding device, such as a video encoder or a video decoder, may be configured to code a parameter set group representing a first parameter set of a first type and a second parameter set of a second, different type, and code a slice of video data using information of the parameter set group, information of the first parameter set, and information of the second parameter set, wherein the slice includes information referring to the parameter set group. The video coding device may further code the first and second parameter sets.

This application claims the benefit of:

U.S. provisional application 61/557,380, filed Nov. 8, 2011;

U.S. provisional application 61/584,626, filed Jan. 9, 2012; and

U.S. provisional application 61/590,702, filed Jan. 25, 2012, the entire contents of each of which are hereby incorporated by reference.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques include spatial (intra-picture) prediction and/or temporal (inter-picture) prediction to reduce or remove redundancy inherent in video sequences. For block-based video coding, a video slice (e.g., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

### SUMMARY

In general, this disclosure describes techniques for utilizing signaling data of parameter sets. The techniques include grouping two or more types of parameter sets into a parameter set group. Video coding may include coding blocks of a slice of video data using parameters signaled by any of the parameter sets of a parameter set group. A slice may include information specifying one of the parameter set groups.

In one example, a method includes coding a parameter set group representing a first parameter set of a first type and a second parameter set of a second, different type, and coding a slice of video data using information of the parameter set group, information of the first parameter set, and information of the second parameter set, wherein the slice includes information referring to the parameter set group.

In another example, a device includes a video coder configured to code a parameter set group representing a first parameter set of a first type and a second parameter set of a second, different type, and code a slice of video data using information of the parameter set group, information of the first parameter set, and information of the second parameter set, wherein the slice includes information referring to the parameter set group.

In another example, a device includes means for coding a parameter set group representing a first parameter set of a first type and a second parameter set of a second, different type, and means for coding a slice of video data using information of the parameter set group, information of the first parameter set, and information of the second parameter set, wherein the slice includes information referring to the parameter set group.

In another example, a computer-readable storage medium has stored thereon instructions that, when executed, cause a processor of a device for coding video data to code a parameter set group representing a first parameter set of a first type and a second parameter set of a second, different type, and code a slice of video data using information of the parameter set group, information of the first parameter set, and information of the second parameter set, wherein the slice includes information referring to the parameter set group.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize techniques for utilizing signaling data of parameter set groups.

FIG. 2 is a block diagram illustrating an example of video encoder that may implement techniques for utilizing signaling data using parameter set groups.

FIG. 3 is a block diagram illustrating an example of video decoder that may implement techniques for utilizing signaling data in parameter set groups.

FIG. 4 is a conceptual diagram illustrating an example parameter set grouping consistent with one or more examples of this disclosure.

FIG. 5 is a conceptual diagram illustrating slice headers that refer to different parameter set group IDs.

FIG. 6 is a flowchart illustrating an example method for encoding a current block of video data using data signaled by a parameter set group.

FIG. 7 is a flowchart illustrating an example method for decoding a current block of video data using data signaled by a parameter set group.

FIG. 8 is a flowchart illustrating an example method for coding parameter sets of a variety of different types and parameter set groups indicating parameter sets of each type.

### DETAILED DESCRIPTION

In general, this disclosure describes techniques for utilizing signaling data of parameter sets. The techniques include grouping two or more types of parameter sets into a parameter set group. Video coding may include coding blocks of a slice of video data using parameters signaled by any of the parameter sets of a parameter set group. A slice may include information specifying one of the parameter set groups.

Different types of parameter sets include parameter sets applicable to different hierarchical levels of video data. For example, types of parameter sets may include any or all of video parameter sets (VPSs) applicable to sequences of pictures in one or more layers of video data, sequence parameter sets (SPSs) applicable to pictures of a sequence of video data within one layer, picture parameter sets (PPSs) applicable to individual pictures, and adaptation parameter sets (APSs) applicable to individual slices within pictures. A parameter set group may include data referring to one parameter set of each available type.

In this manner, video data may refer to an identifier of the parameter set group in order to indicate which parameter set of each type applies to the video data. For example, a slice of video data may include a parameter set group identifier in the header of the slice, and the parameter set group corresponding to the parameter set group identifier may indicate one parameter set from each type of parameter set including parameters used to code the slice. In particular, a video coder, such as a video encoder or video decoder, may code data of a slice including a parameter set group identifier, and code data of the slice using parameters of various types of parameter sets corresponding to the parameter set group. Thus, these techniques may achieve a bitrate savings, in that a slice may simply refer to the parameter set group identifier, rather than identifiers for each type of parameter set.

The video coder may further code the parameter set group and parameter sets. To distinguish the parameter sets and parameter set group, the video coder may code separate network abstraction layer (NAL) units including the parameter sets and parameter set group. For example, the video coder may code different types of NAL units to include the parameter sets from each other and/or the parameter set group. Alternatively, the same type of NAL unit may be used to encapsulate parameter sets and parameter set groups, but may differ from NAL unit types encapsulating video data. In such an example, the parameter set data may include parameter set type identifier data, and likewise, the parameter set group data may include a type identifier.

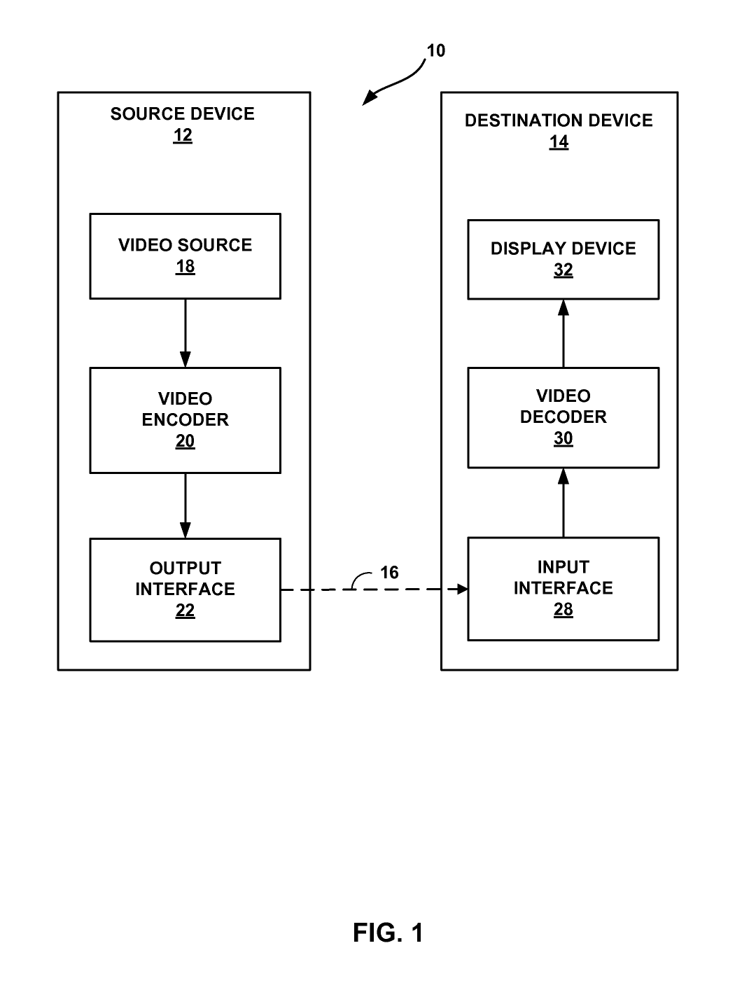

FIG. 1 is a block diagram illustrating an example video encoding and decoding system 10 that may utilize techniques for utilizing signaling data in parameter set groups. As shown in FIG. 1, system 10 includes a source device 12 that provides encoded video data to be decoded at a later time by a destination device 14. In particular, source device 12 provides the video data to destination device 14 via a computer-readable medium 16. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In some examples, encoded data may be output from output interface 22 to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device 12. Destination device 14 may access stored video data from the storage device via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes video source 18, video encoder 20, and output interface 22. Destination device 14 includes input interface 28, video decoder 30, and display device 32. In accordance with this disclosure, video encoder 20 of source device 12 may be configured to apply the techniques for utilizing signaling data of parameter sets. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Techniques for utilizing signaling data of parameter sets may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be output by output interface 22 onto a computer-readable medium 16.

Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

Input interface 28 of destination device 14 receives information from computer-readable medium 16. The information of computer-readable medium 16 may include syntax information defined by video encoder 20, which is also used by video decoder 30, that includes syntax elements that describe characteristics and/or processing of blocks and other coded units, e.g., GOPs. Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

Video encoder 20 and video decoder 30 may operate according to a video compression standard, such as the High Efficiency Video Coding (HEVC) standard presently under development, and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video compression standards include MPEG-2 and ITU-T H.263. Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

The ITU-T H.264/MPEG-4 (AVC) standard was formulated by the ITU-T Video Coding Experts Group (VCEG) together with the ISO/IEC Moving Picture Experts Group (MPEG) as the product of a collective partnership known as the Joint Video Team (JVT). In some aspects, the techniques described in this disclosure may be applied to devices that generally conform to the H.264 standard. The H.264 standard is described in ITU-T Recommendation H.264, Advanced Video Coding for generic audiovisual services, by the ITU-T Study Group, and dated March, 2005, which may be referred to herein as the H.264 standard or H.264 specification, or the H.264/AVC standard or specification. The Joint Video Team (JVT) continues to work on extensions to H.264/MPEG-4 AVC.

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

The JCT-VC is working on development of the HEVC standard. The HEVC standardization efforts are based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three intra-prediction encoding modes.

In general, the working model of the HM describes that a video frame or picture may be divided into a sequence of treeblocks or largest coding units (LCU) that include both luma and chroma samples. Syntax data within a bitstream may define a size for the LCU, which is a largest coding unit in terms of the number of pixels. A slice includes a number of consecutive treeblocks in coding order. A video frame or picture may be partitioned into one or more slices. Each treeblock may be split into coding units (CUs) according to a quadtree. In general, a quadtree data structure includes one node per CU, with a root node corresponding to the treeblock. If a CU is split into four sub-CUs, the node corresponding to the CU includes four leaf nodes, each of which corresponds to one of the sub-CUs.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, four sub-CUs of a leaf-CU will also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split.

A CU has a similar purpose as a macroblock of the H.264 standard, except that a CU does not have a size distinction. For example, a treeblock may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a treeblock may be split, referred to as a maximum CU depth, and may also define a minimum size of the coding nodes. Accordingly, a bitstream may also define a smallest coding unit (SCU). This disclosure uses the term “block” to refer to any of a CU, PU, or TU, in the context of HEVC, or similar data structures in the context of other standards (e.g., macroblocks and sub-blocks thereof in H.264/AVC).

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square (e.g., rectangular) in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

A leaf-CU may include one or more prediction units (PUs). In general, a PU represents a spatial area corresponding to all or a portion of the corresponding CU, and may include data for retrieving a reference sample for the PU. Moreover, a PU includes data related to prediction. For example, when the PU is intra-mode encoded, data for the PU may be included in a residual quadtree (RQT), which may include data describing an intra-prediction mode for a TU corresponding to the PU. As another example, when the PU is inter-mode encoded, the PU may include data defining one or more motion vectors for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

A leaf-CU having one or more PUs may also include one or more transform units (TUs). The transform units may be specified using an RQT (also referred to as a TU quadtree structure), as discussed above. For example, a split flag may indicate whether a leaf-CU is split into four transform units. Then, each transform unit may be split further into further sub-TUs. When a TU is not split further, it may be referred to as a leaf-TU. Generally, for intra coding, all the leaf-TUs belonging to a leaf-CU share the same intra prediction mode. That is, the same intra-prediction mode is generally applied to calculate predicted values for all TUs of a leaf-CU. For intra coding, a video encoder may calculate a residual value for each leaf-TU using the intra prediction mode, as a difference between the portion of the CU corresponding to the TU and the original block. A TU is not necessarily limited to the size of a PU. Thus, TUs may be larger or smaller than a PU. For intra coding, a PU may be collocated with a corresponding leaf-TU for the same CU. In some examples, the maximum size of a leaf-TU may correspond to the size of the corresponding leaf-CU.

Moreover, TUs of leaf-CUs may also be associated with respective quadtree data structures, referred to as residual quadtrees (RQTs). That is, a leaf-CU may include a quadtree indicating how the leaf-CU is partitioned into TUs. The root node of a TU quadtree generally corresponds to a leaf-CU, while the root node of a CU quadtree generally corresponds to a treeblock (or LCU). TUs of the RQT that are not split are referred to as leaf-TUs. In general, this disclosure uses the terms CU and TU to refer to leaf-CU and leaf-TU, respectively, unless noted otherwise.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data for the TUs of the CU. The PUs may comprise syntax data describing a method or mode of generating predictive pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Following quantization, the video encoder may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array. In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

Video encoder 20 may further send syntax data, such as block-based syntax data, frame-based syntax data, and GOP-based syntax data, to video decoder 30, e.g., in a frame header, a block header, a slice header, or a GOP header. The GOP syntax data may describe a number of frames in the respective GOP, and the frame syntax data may indicate an encoding/prediction mode used to encode the corresponding frame. Video encoder 20 may also code syntax data in parameter set data structures, and video decoder 30 may decode parameter set data structures. Parameter sets may contain sequence-level header information in sequence parameter sets (SPS) and infrequently changing picture-level information in picture parameter sets (PPS). Moreover, video parameter sets (VPS) may include signaling information that applies to multiple layers of a video bitstream (where layers may represent various views, various spatial resolutions, various frame rates, various bit depths, or the like). With parameter sets (e.g., PPS, SPS, and VPS), infrequently changing information need not to be repeated for each sequence, picture, or layer. Hence, coding efficiency may be improved.

Furthermore, the use of parameter sets may enable out-of-band transmission of the important header information, avoiding the need for redundant transmissions for error resilience. The sequence and picture parameter set mechanism decouples the transmission of infrequently changing information from the transmission of coded block data. Sequence and picture parameter sets may, in some applications, be conveyed “out-of-band” using a reliable transport mechanism. A picture parameter set raw byte sequence payload (RBSP) includes parameters that can be referred to by the coded slice network abstraction layer (NAL) units of one or more coded pictures. A sequence parameter set RBSP includes parameters that can be referred to by one or more picture parameter set RBSPs or one or more SEI NAL units containing a buffering period SEI message. A sequence parameter set RBSP includes parameters that can be referred to by one or more picture parameter set RBSPs or one or more SEI NAL units containing a buffering period SEI message.

In addition to the VPS, SPS, and PPS, parameter sets may include an adaptation parameter sets, as disclosed in Wenger et al., “Adaptation Parameter Set (APS),” Joint Collaborative Team on Video Coding (JCT-VC) of ITU-T SG16 WP3 and ISO/IEC JTC1/SC29/WG11, 6^{th} Meeting: Torino, IT, Jul. 14-22, 2011, Document JCTVC-F747r3, available at http://phenix.int-evey.fr/jct/doc_end user/documents/6_Torino/wg11/JCTVC-F747-v4.zip. It is possible to put more picture-level parameters into an APS, or similar data structures. However, this may cause one or more problems, such as the following problems. If different sets of information are put into e.g., one type of parameter set RBSP, if one set is changed, even if the other parts don't change, a new parameter set has to be sent, causing bandwidth utilization to increase. If prediction between two parameter sets of the same type is enabled, signaling the parameter sets in-band may be less error resilient than signaling the parameter sets out-of-band.

The techniques of this disclosure, which may be implemented by source device 12 and destination device 14 (e.g., by video encoder 20 and video decoder 30, or other units of source device 12 and destination device 14), generally include utilization of a slice header that can refer to multiple types of parameter sets needed for the decoding of a current slice. For example, video encoder 20 and video decoder 30 may be configured to code parameter sets of various types, code a grouping parameter set that refers to parameter sets of each of the types, and code a slice including information referring to one of the grouping parameter sets. This disclosure also describes a specific NAL unit type for a parameter set grouping RBSP. Inside this parameter grouping RBSP, each group may include multiple references (e.g., pointers), each of which may refer to a different type of parameter set. More specifically, each grouping identifier (ID) may have a list of parameter set IDs, each of which may correspond to a valid ID for a type of parameter set.

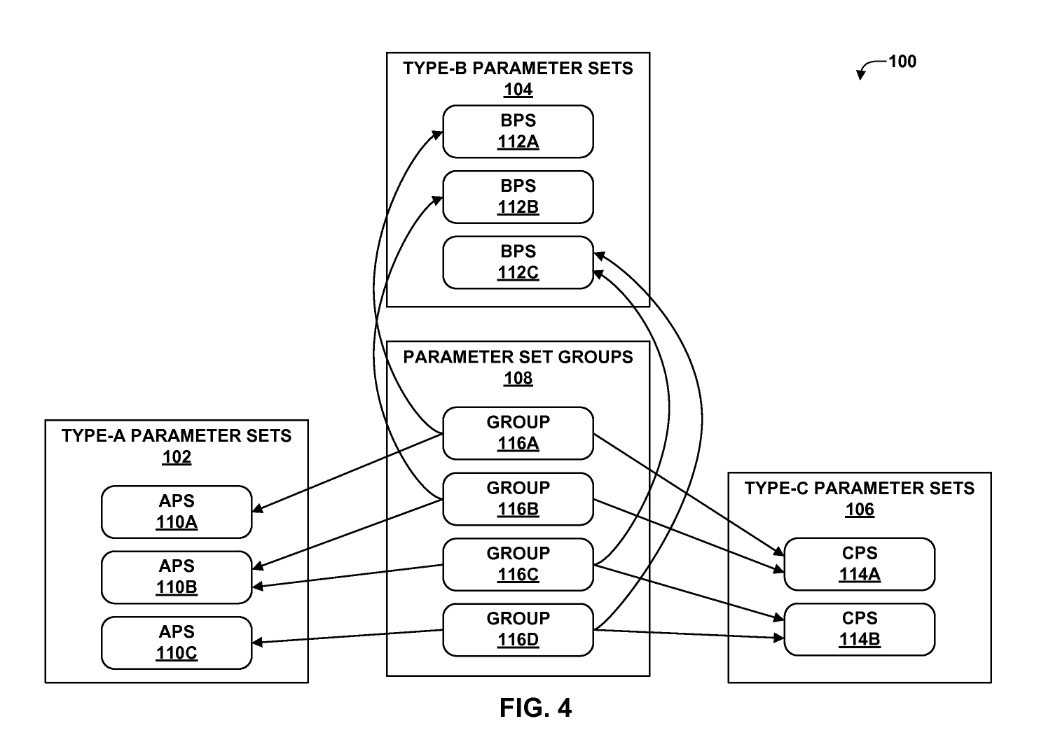

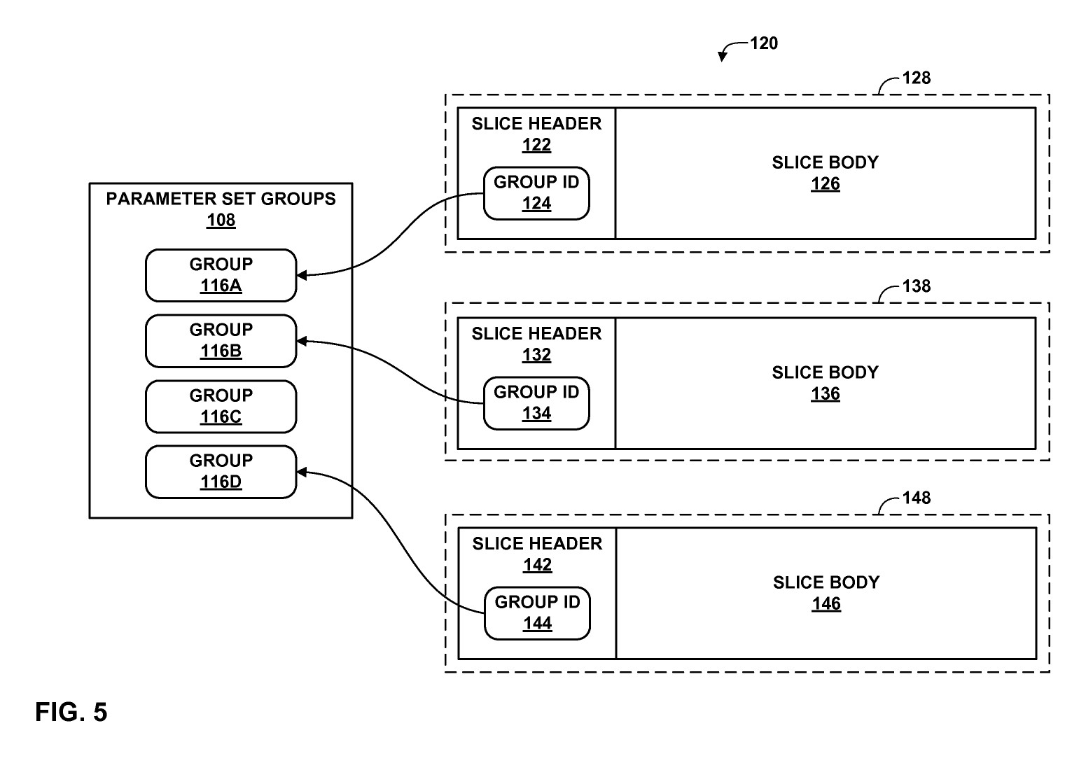

The grouping ID itself may be signaled in the slice header, and thus, the IDs for different kinds parameter sets do not need to be signaled in the slice header. An example of the parameter set grouping is shown in FIG. 4, while an example of various slice headers referring to different grouping IDs is shown in FIG. 5. FIGS. 4 and 5 are discussed in greater detail below. Possible parameter set types may be parameter sets related to sample adaptive offsets (SAOs), parameter sets related to adaptive loop filters (ALFs), parameter sets related to quantization matrices, parameter sets related to reference picture list construction, parameter sets related to reference picture management (reference picture set parameter set), or parameter sets related to other video parameters.

There may be various hierarchical levels, in terms of the scopes of various parameter sets. For example, a sequence parameter set (SPS) may apply to a whole coded video sequence, picture parameter set (PPS) may apply to one or more pictures in a group, similar to a sub-sequence, and may refer to a specific SPS, and other types of parameter sets may apply to a slice, a group of slices, a picture or several pictures, all of which may refer to a specific PPS.

In one example, the slice-level or picture-level parameter sets may be defined with different NAL unit types in a particular order, e.g., as shown in the example of Table 1:

TABLE 1

| Parameter | | NAL unit |
|---|---|---|
| Set Type | Name | type value |
| 0 | Parameter Set Type 0 | value x |
| | (e.g., ALF parameters et) | |
| 1 | Parameter Set Type 1 | value x+1 |
| | (e.g., SAO parameter set) | |
| 2 | Parameter Set Type 2 | value x+2 |
| | (e.g., Quantization | |
| | matrices parameter set) | |
| 3 | Parameter Set Type 3 | value x+3 |
| | (e.g., reference picture | |
| | set parameter set) | |

The NAL unit types used here are different from the NAL unit types of other types of NAL units, e.g., SPS, PPS and VCL NAL units. That is, the NAL unit types represented in Table 1 are not necessarily the same as NAL unit types for NAL units that encapsulate SPSs, PPSs, and encoded video data. In this manner, the NAL unit types, e.g., of Table 1, may identify a type of parameter set included in a corresponding NAL unit. For example, video encoder 20 may encode a parameter set of a particular type, encapsulate the parameter set in a NAL unit, and code a NAL unit type value in a NAL unit header for the NAL unit, such that the NAL unit type value represents the parameter set type encapsulated by the NAL unit. Likewise, video decoder 30 may receive a NAL unit, determine a NAL unit type value for the NAL unit, and thereby determine a type of parameter set (or other data, e.g., coded video data) encapsulated by the NAL unit.

In this manner, video encoder 20 and video decoder 30 may be configured to code a first NAL unit type for a first NAL unit encapsulating a first parameter set conforming to a first type, wherein the first NAL unit type is representative of the first type for the first parameter set, and to code a second, different NAL unit type for a second NAL unit encapsulating a second parameter set conforming to a second, different type, wherein the second NAL unit type is representative of the second type for the second parameter set.

Likewise, video encoder 20 and video decoder 30 may be further configured to determine a correspondence between the first type for the first parameter set and the first NAL unit type according to data (e.g., data conforming to Table 1) that defines an order for parameter set types, wherein the data represents parameter set types using respective offset values (e.g., x+N in the “NAL unit type value” column of Table 1) from a predetermined NAL unit type value (e.g., “x” in the “NAL unit type value” column of Table 1) according to the defined order, and determine a correspondence between the second type for the second parameter set and the second NAL unit type according to the data (e.g., data conforming to Table 1) that defines the order for the parameter set types.

Although video encoder 20 and video decoder 30 are described above as encapsulating and decapsulating parameter sets, respectively, it should be understood that other units of source device 12 and destination device 14 may perform the encapsulation and decapsulation. For example, output interface 22 of source device 12 may encapsulate a parameter set in a NAL unit, and input interface 28 may be configured to decapsulate a NAL unit to extract an encapsulated parameter set. Alternatively, source device 12 and destination device 14 may include dedicated encapsulation and decapsulation units, which may be implemented as multiplexers and demultiplexers, respectively. For other instances of this disclosure in which video encoder 20 and video decoder 30 are described as coding NAL units and NAL unit headers, it should also be understood that the coding of the NAL units may instead be realized by separate encapsulation and decapsulation units.

In another example, two or more different types of parameter sets may use the same NAL unit type value, but a parameter set type value is signaled as a syntax element after the NAL unit header. That is, video encoder 20 may code a parameter set of a particular type, code a type value for the parameter set, and then encapsulate the parameter set in a NAL unit of a particular NAL unit type. Video encoder 20 may similarly encapsulate other parameter sets of other parameter set types in NAL units of the same NAL unit type. In this manner, video decoder 30 may use the NAL unit type to determine whether a NAL unit includes a parameter set or other data, and if a parameter set, video decoder 30 may determine the parameter set type using a parameter set type value coded for the parameter set. Table 2 provides an example syntax for such parameter sets:

TABLE 2

| | Descriptor |
|---|---|
| param_set_rbsp( ) { | |
| param_set_type | ue(v) |
| ... | |
| rbsp_trailing_bits( ) | |
| } | |

In this example, param_set_type specifies the type of the parameter set RBSP. For example, the values 0, 1, 2, and 3 may specify that the parameter set RBSP is parameter set type 0, 1, 2, and 3, respectively.

In this manner, video encoder 20 and video decoder 30 may be configured to code a first NAL unit comprising a first parameter set conforming to a first type, wherein a first header of the first NAL unit comprises a NAL unit type value, code a first parameter set type value following the first header of the first NAL unit, wherein the first parameter set type value specifies the first type for the first parameter set, code a second NAL unit comprising a second parameter set conforming to a second, different type, wherein a second header of the second NAL unit comprises the NAL unit type value of the first NAL unit, and code a second parameter set type value following the second header of the second NAL unit, wherein the second parameter set type value specifies the second type for the second parameter set.

Similarly, video encoder 20 and video decoder 30 need not necessarily be configured to encapsulate parameter sets of different types in NAL units of a common NAL unit type. Thus, video encoder 20 and video decoder 30 may be configured to simply code a first parameter set type value for a first parameter set, wherein the first parameter set type value is representative of a first type to which the first parameter set conforms, and to code a second parameter set type value for a second parameter set, wherein the second parameter set type value is representative of a second, different type to which the second parameter set conforms.

In some examples, different types of adaptation parameter sets may use the same NAL unit type with the syntax of Table 2 above (with “param_set_rbsp( )” being changed to “aps_rbsp( )”), and each value of param_set_type may specify one type of adaptation parameter set. For example, the value 0 may specify that the adaptation parameter set is an ALF adaptation parameter set, the value 1 may specify that the adaptation parameter set is an SAO adaptation parameter set, the value 2 may specify that the adaptation parameter set is a quantization matrix adaptation parameter set, and the value 3 may specify that the adaptation parameter set is a reference picture set adaptation parameter set.

Table 3 provides an example parameter set grouping RBSP syntax:

TABLE 3

| | Descriptor |
|---|---|
| para_set_grouping_rbsp( ) { | |
| number_signalled_para_set_groups_minus1 | ue(v) |
| for( i = 0; i<= number_signalled_para_set_groups_minus1; | |
| i++) { | |
| para_set_group_id[ i ] | ue(v) |
| for (j= 0; j< numParaSetTypes; j++) | |
| para_set_type_id[ i ][ j ] | |
| } | |
| rbsp_trailing_bits( ) | |
| } | |

The semantics of this data structure may be defined as follows:

At least one parameter set grouping RBSP shall be present in the bitstream. When more than one parameter set grouping RBSP is present in the bitstream, a later one in decoding order overwrites the previous one if both of them have a same para_set_group_id[i] signaled, the assigned IDs of various parameter sets are always set to the values signaled in the later parameter set grouping RBSP for the parameter set group with ID equal to para_set_group_id[i]. This way, a list of parameter set groups {(ParaSetGrouplD[i′], ParaSetTypeID[i′][j])} is maintained and the number of entries in the list may vary.

In this example, number_signalled_para_set_groups_minus1 plus 1 specifies the number of parameter groups signaled. This value shall be in the range of 0 to 30, inclusive.

In this example, para_set_group_id[i] specifies the ID of the i-th signalled parameter set group. The value of para_set_group_id[i] shall be in the range of 0 to 31, inclusive.

In this example, para_set_type_id[i][j] specifies the ID of the j-th parameter set type for the i-th parameter set group.

The example of Table 3 represents an example definition of a parameter set group data structure. The parameter set group data structure may generally include data representing a plurality of parameter sets of various types, e.g., a first parameter set of a first type and a second parameter set of a second, different type. As shown in the example of Table 3, each parameter set group specifies one parameter set for each available type of parameter set. Moreover, the parameter set group ID of Table 3 represents an example of information referring to a parameter set group.

Accordingly, video encoder 20 and video decoder 30 may specify a parameter set group ID in a slice header of a slice, and the parameter sets identified by the parameter set group ID may be used to code data of the slice. Table 4 provides an example slice header syntax:

TABLE 4

| | Descriptor |
|---|---|
| slice_header( ) { | |
| lightweight_slice_flag | u(1) |
| if( !lightweightslice_flag ) { | |
| slice_type | ue(v) |
| pic_parameter_set_id | ue(v) |
| para_set_group_id | ue(v) |
| ... | |
| } | |
| } | |

Note that, in the example of Table 4, the condition “if(sample_adaptive_offset_enabled_flag∥adaptive_loop_filter_enabled_flag), followed by “aps_id” in the conventional slice header syntax has been removed, and para_set_group_id has been added, per the techniques of this disclosure.

The semantics of the slice header syntax may be defined as follows:

In this example, para_set_group_id specifies the ID of the parameter set group used to derive the parameter sets of the current slice. Assume parameter_set_group_id equal to ParaSetGroupID[n], the parameter set ID for the j-th type is ParaSetTypeID[n][j].

Thus, video encoder 20 and video decoder 30 may be configured to code a slice header of a slice, wherein the slice header includes data corresponding to a parameter set group identifier (ID). In particular, when video encoder 20 codes a slice using parameters of a particular combination of parameter sets of different types, video encoder 20 may form a parameter set group that identifies the parameter sets of the different types, assign a parameter set group ID to the parameter set group, and then code a value representing the parameter set group ID in the slice, e.g., in the slice header. Likewise, video decoder 30 may determine which parameters to apply when decoding a slice by determining a parameter set group ID coded in data of the slice (e.g., in a slice header), determine which parameter sets of various types are represented by the parameter set group corresponding to the parameter set group ID, and decode the slice using parameters of the parameter sets represented by the parameter set group.

In another example, different types of parameter sets may be defined. Table 5 provides an example of an adaptive loop filter (ALF) parameter set RBSP syntax:

TABLE 5

| | Descriptor |
|---|---|
| alf_ps_rbsp( ) { | |
| alf_ps_id | ue(v) |
| adaptive_loop_filter_flag | u(1) |
| if( adaptive_loop_filter_flag ) { | |
| alf_cabac_use_flag | u(1) |
| if( alf cabac_use_flag ) { | |
| alf_cabac_init_idc | ue(v) |
| alf_cabac_init_qp_minus26 | se(v) |
| } | |
| } | |
| /* Insert non-CABAC subject matter above this line */ | |
| if( aps_adaptive_loop_filter_flag ) { | |
| alf_data_byte_count /* to enable skipping past data without parsing it */ | u(8) |
| /* byte_align() this byte align to happen between the non-CABAC and | |
| CABAC parts of the alf_param( ) Once there is an all CABAC alf_param( ), | |
| enable this byte_align( ) */ | |
| alf_param( ) | |
| byte_align() | |
| } | |
| rbsp_trailing_bits( ) | |
| } | |

The semantics for the ALF parameter set RBSP may be defined as follows:

In this example, alf_ps_id identifies the ALF parameter set. That is, alf_ps_id is the ID of a particular ALF parameter set.

In this example, adaptive_loop_filter_flag equal to 1 specifies that the ALF is on for slices referred to the current parameter set; equal to 0 specifies that the ALF is off for slices referred to the current parameter set. If there is no active ALF parameter set or it is empty, the adaptive_loop_filter_flag value is inferred to be 0.

In this example, cabac_use_flag equal to 1 specifies that the CABAC decoding process shall be used for alf_param( ) when present; equal to 0 specifies that the CAVLC decoding process shall be used for and alf_param( ) when present.

In this example, cabac_init_idc specifies the index for determining the initialisation table used in the initialisation process for context variables of ALF. The value of cabac_init_idc shall be in the range of 0 to 2, inclusive.

In this example, aps_cabac_init_qp_minus26 specifies a quantization parameter minus 26 wherein the quantization parameter is used in the initialization process for context variables of ALF.

In this example, alf_data_byte_count specifies the number of bytes.

Table 6 provides an example of a sample adaptive offset (SAO) parameter set RBSP syntax:

TABLE 6

| | Descriptor |
|---|---|
| sao_ps_rbsp( ) { | |
| sao_ps_id | ue(v) |
| sample_adaptive_offset_flag | u(1) |
| if(sample_adaptive_offset_flag) { | |
| sao_cabac_use_flag | u(1) |
| if( sao_cabac_use_flag ) { | |
| sao_cabac_init_idc | ue(v) |
| sao_cabac_init_qp_minus26 | se(v) |
| } | |
| } | |
| /* insert CABAC subject matter below this line; make sure its byte-aligned */ | |
| if( aps_sample_adaptive_offset_flag ) { | |
| sao_data_byte_count /* to enable skipping past data without parsing it */ | u(8) |
| byte_align ( ) | |
| sao_param( ) | |
| /* byte_align( ) this final byte align unnecessary as being taken care of by | |
| rbsp_trailing_bits( ) */ | |
| rbsp_trailing_bits( ) | |
| } | |

The semantics for the SAO parameter set RBSP may be defined as follows:

In this example, sao_ps_id identifies the SAO parameter set. In other words, sao_ps_id is the ID of this SAO parameter set.

In this example, sample_adaptive_offset_flag equal to 1 specifies that the SAO is on for slices referred to the current APS; equal to 0 specifies that the SAO is off for slices referred to the current APS. If there is no active APS, the sample_adaptive_offset_flag value is inferred to be 0.

In this example, cabac_use_flag equal to 1 specifies that the CABAC decoding process shall be used for sao_param( ) when present; equal to 0 specifies that the CAVLC decoding process shall be used for and sao_param( ) when present.

In this example, cabac_init_idc specifies the index for determining the initialisation table used in the initialisation process for context variables of SAO. The value of cabac_init_idc shall be in the range of 0 to 2, inclusive.

In this example, aps_cabac_init_qp_minus26 specifies a quantization parameter minus twenty-six (26), wherein the quantization parameter is used in the initialization process for context variables of SAO.

In this example, sao_data_byte_point specifies the number of bytes.

Table 7 provides an example of a quantization matrix table parameter set RBSP syntax:

TABLE 7

| | Descriptor |
|---|---|
| qm_parameter_setrbsp( ) { | |
| qm_ps_id | ue(v) |
| quantization_matrix_flag | u(1) |
| if ( quantization_matrix_flag ) | |
| quantization_matrix_table( ) | |
| rbsp_trailing_bits( ) | |
| } | |

The semantics for the quantization matrix table parameter set RBSP may be defined as follows:

In this example, qm_ps_id identifies the quantization matrix table parameter set. That is, qm_ps_id is the ID of this quantization matrix table parameter set.

In this example, quantization_matrix_flag specifies whether quantization matrices are signaled in this APS. This syntax element equal to 0 indicates that quantization matrices are not signaled in this APS and not used for coded pictures referring to this APS. This syntax element equal to 1 indicates that quantization matrices are signaled in this APS and are used for coded pictures referring to this APS.

Table 8 provides an example of a reference picture list construction parameter set RBSP syntax:

TABLE 8

| | Descriptor |
|---|---|
| rplc_ps_rbsp( ) { | |
| rplc_ps_id | ue(v) |
| if( slice_type = = P ∥ slice_type = = B ) { | |
| num_ref _idx_active_override_flag | u(1) |
| if( num_ref_ idx_active_override_flag ) { | |
| num_ref _idx_10_active_minus1 | ue(v) |
| if( slice_type = = B ) | |
| num_ref idx_l1_active_minus1 | ue(v) |
| } | |
| } | |
| ref_pic_list_modification( ) | |
| ref_pic_list_combination( ) | |
| rbsp_trailing_bits( ) | |
| } | |

The semantics for the reference picture list construction parameter set RBSP may be defined as follows:

In this example, rplc_ps_id identifies the reference picture list construction parameter set. That is, rplc_ps_id is the ID of the reference picture list construction parameter set. Other syntax elements may have the same semantics as those in the current HEVC specification.

Table 9 provides an example of a reference picture set parameter set RBSP syntax:

TABLE 9

| | Descriptor |
|---|---|
| rps_ps_rbsp( ) { | |
| rps_ps_id | ue(v) |
| ref_pic_set( ) | |
| } | |

The semantics for the reference picture set parameter set RBSP may be defined as follows:

In this example, rps_ps_id identifies the reference picture set parameter set. That is, rps_ps_id is the ID of the reference picture set parameter set, in this example.

A reference picture set (ref_pic_set) may include a set of reference pictures associated with a picture, including all reference pictures, excluding the associated picture itself, that may be used for inter prediction of the associated picture or any picture following the associated picture in decoding order, and that have temporal_id less than or equal to that of the associated picture.

In addition or in the alternative, the following modifications to the examples discussed above may be applied. For each parameter set type, an ID of a parameter set belonging to such type may be signaled in the slice header. Some of the parameter sets might not refer to a PPS, but just to an SPS. Some of the parameter sets might not refer to either a PPS or an SPS. The Parameter Set Grouping RBSP may have an inferred syntax value of 0 for number_signalled_para_set_groups_minus1, which is not present in the RBSP syntax. A para_set_type_id[i][j] equal to 0 may be specified that the corresponding parameter set of that type is empty and the syntax elements may be derived to be default values. A flag can be introduced for each parameter set type to indicate if a para_set_type_id[i][j] is signaled. If a particular para_set_type_id[i][j] is not signaled, the corresponding parameter set of that type is empty and the syntax elements may be derived to be default values.

In another example, each APS could contain only one type of information, e.g., one of ALF parameters, SAO parameters, quantization matrices parameters, and deblocking filtering parameters. That is, video encoder 20 may encapsulate each of the various types of information in different types of APSes. Moreover, APSes containing different types of information may share the same APS ID value space. That is, any two APSes containing two different types of information may have different APS ID values. Accordingly, video encoder 20 may assign different APS ID values to APSes including different types of information. In this manner, video decoder 30 may determine a type of information included in an APS based on the APS ID of the APS. Moreover, each grouping parameter set may contain one, or more than one, parameter set group(s).

For each parameter set group in this example, the number (e.g., denoted as N) of different types of APS parameters may be signaled, followed by N APS IDs, and any two of these APSes may refer to two different types of APS parameters. In some examples, video encoder 20 may be configured to ensure that any two of the APSes in a parameter set group refer to two different types of APS parameters, and thus, video decoder 30 may infer that separate APSes in a parameter set group include different APS parameters. In this manner, video encoder 20 and/or video decoder 30 may code information representative of a number of different types of parameter sets and information associating identifier values (e.g., APS IDs) with respective information for the APSes.

In another example, each APS may contain only one type of information, e.g., one of ALF parameters, SAO parameters, quantization matrices parameters, and deblocking filtering parameters. Each type of APS may have its own APS ID value space. That is, two APSes containing two different types of information may have the same APS ID value. Each grouping parameter set may contain one or more than one parameter set group. For each parameter set group, the number of different types of APS parameters may be signaled (e.g., denoted as N), followed by N pairs of APS type and APS ID. In this example, a parameter set group may include two or more APSes of the same type, with the same type of information. Video encoder 20 may signal APS ID values in a slice header of a coded slice referring to the corresponding one of the APSes in the parameter set group. In this manner, video decoder 30 may use the signaled APS ID to determine parameters for a coded slice of video data.

In another example, each APS may contain one or more types of information, e.g., one or more of ALF parameters, SAO parameters, quantization matrices parameters, and deblocking filtering parameters. Each type of APS may have its own APS ID value space, i.e., two APS's containing two different types of information may have the same APS ID value. Each grouping parameter set may contain one, or more than one, parameter set group. For each parameter set group, the number of different types of APS parameters may be signaled (e.g., denoted as N), followed by N pairs of APS ID and APS information type.

In some examples, a grouping parameter set may contain only one parameter set group. In other examples, one NAL unit may contain information of multiple groups. In this example, an APS may contain different types of information. Table 10 provides an example group parameter set RBSP syntax:

TABLE 10

| | Descriptor |
|---|---|
| group_parameter_set_rbsp( ) { | |
| group_parameter_set_id | ue(v) |
| for( i = 0; i < Num_Type_APSs; i++) | |
| aps_id_plus1[ i ] | ue(v) |
| gps_extension_flag | u(1) |
| if( gps_extension_flag ) | |
| while( more_rbsp_data( ) ) | |
| gps_extension_data_flag | u(1) |
| rbsp_trailing_bits( ) | |
| } | |

The semantics for the group parameter set RBSP may be defined as follows:

In this example, group_parameter_set_id identifies a group parameter set. The value of group_parameter_set_id may be in the range of 0 to 255, inclusive.

In this example, Num_Type_APSs is derived to be the number of different types of adaptation parameter sets defined by the codec. For example, if there are three different types, such as (1) quantization parameter APS, (2) ALF APS, and (3) SAO APS, Num_Type_APSs is derived to be 3.

In this example, aps_id_plus1[i] equal to 0 indicates that the i-th adaptaion parameter set referred to by the group parameter set is not present, meaning that pictures referring to this group parameter set do not rely on the i-th type of information signalled in the APS for decoding. When aps_id_plus1[i] is larger than 0, aps_id_plus1[i] minus 1 identifies the i-th adaptation parameter set referred by the group parameter set.

Note that the same value of the aps_id_plus1[i] may be present in the loop more than once. In this case, more than one type of information is collected from the same APS.

In this manner, video encoder 20 and video decoder 30 represent examples of a video coder configured to code a parameter set group representing a first parameter set of a first type and a second parameter set of a second, different type, and code a slice of video data using information of the parameter set group, information of the first parameter set, and information of the second parameter set, wherein the slice includes information referring to the parameter set group. The video coder may be further configured to code the first parameter set and the second parameter set.

In particular, coding the parameter set group may include coding data that associates a parameter set group identifier (ID) with the first parameter set and the second parameter set. For example, video encoder 20 may form a group parameter set in accordance with Table 3 and/or Table 10, as described above. The group parameter set may list a group ID and identifiers for one parameter set of each type iteratively, e.g., as shown in Table 3 and Table 10. Although only two parameter sets are described in this example, it should be understood that video encoder 20 may form a group parameter set that maps a group ID to a plurality of different types of parameter sets. Similarly, video decoder 30 may decode such a group parameter set. Video encoder 20 and video decoder 30 may code multiple parameter set groups, e.g., a group parameter set that lists a plurality of group IDs (e.g., in accordance with Table 3) or a plurality of separate group parameter sets that each include a respective group ID and set of associated parameter sets of each type (e.g., in accordance with Table 10).

Video encoder 20 and video decoder 30 may also code video data in accordance with a parameter set group. In particular, video encoder 20 may code video data using parameters of a particular combination of parameter sets of various types, and select or code a parameter set group corresponding to that combination of parameter sets. In this manner, video encoder 20 may encode a slice of video data using information of a parameter set group. Moreover, video encoder 20 may encode the video data of the slice using information of the first parameter set and second parameter set based on the correspondence between the group ID and the first and second parameter sets. That is, video encoder 20 may code the video data of the slice using the first and second parameter sets, and code the group ID corresponding to the first and second parameter sets. Video encoder 20 may encode the group ID in data of the slice, e.g., in a slice header of the slice.

Video decoder 30, on the other hand, may determine the first and second parameter sets based on data of the slice identifying the parameter set group. For example, video decoder 30 may decode a slice header of the slice and determine that the slice header includes data identifying a group ID of the parameter set group. Based on this determination, video decoder 30 may determine that video data of the slice is coded using parameters of the first parameter set and the second parameter set. That is, video decoder 30 may determine that the group ID corresponds to the first and second parameter sets, and thus, that the video data of the slice is coded using the first and second parameter sets. In this manner, video encoder 20 and video decoder 30 may code a slice of video data using information of the parameter set group, information of the first parameter set, and information of the second parameter set, wherein the slice includes information referring to the parameter set group.

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 20 and video decoder 30 may be included in one or more encoders or decoders, either of which may be integrated as part of a combined video encoder/decoder (CODEC). An apparatus including video encoder 20 and/or video decoder 30 may comprise an integrated circuit, a microprocessor, and/or a wireless communication device, such as a cellular telephone.

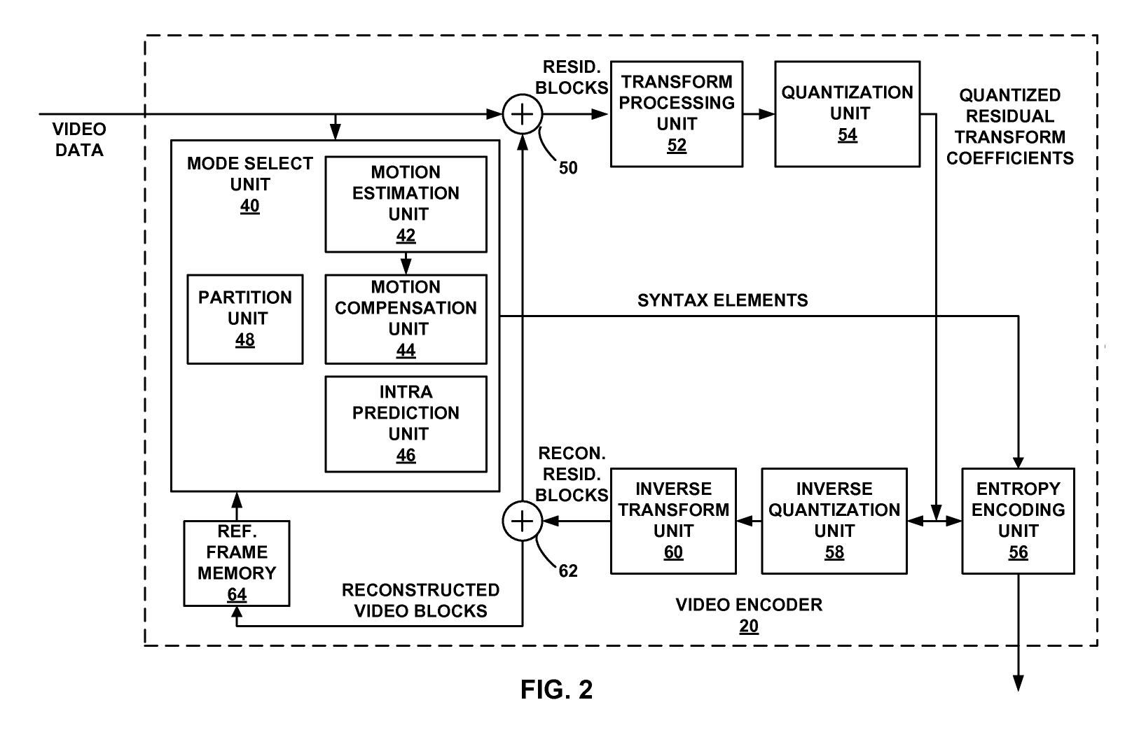

FIG. 2 is a block diagram illustrating an example of video encoder 20 that may implement techniques for utilizing signaling data using parameter set groups. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes.

As shown in FIG. 2, video encoder 20 receives a current video block within a video frame to be encoded. In the example of FIG. 2, video encoder 20 includes mode select unit 40, reference frame memory 64, summer 50, transform processing unit 52, quantization unit 54, and entropy encoding unit 56. Mode select unit 40, in turn, includes motion compensation unit 44, motion estimation unit 42, intra-prediction unit 46, and partition unit 48. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

When provided, an in-loop filter that filters the output of summer 62 may be configured to utilize an adaptive loop filter (ALF). More particularly, the in-loop filter may utilize ALF parameters to perform filtering. When an in-loop filter filters blocks of a slice using ALF parameters, video encoder 20 may encode the ALF parameters in an ALF parameter set, e.g., as discussed with respect to Table 5. In accordance with the techniques of this disclosure, video encoder 20 may encode a parameter set group that identifies the ALF parameter set, and encode data in the slice (e.g., a slice header of the slice) that identifies the parameter set group.

In-loop processing may also, or alternatively, include adjusting pixel values of blocks of a slice according to sample adaptive offset (SAO) parameters. In some examples, an SAO filter may be configured to perform various types of offset filtering, such as band offset filtering and/or edge offset filtering. An SAO filter may also at times apply no offset, which can itself be considered a third type of offset filtering. The type of offset filtering applied by an SAO filter may be either explicitly or implicitly signaled, e.g., as SAO parameters. For example, video encoder 20 may construct an SAL parameter set as discussed with respect to Table 6. When applying edge offset filtering, pixels can be classified based on edge information of a coding unit, and an offset can be determined for pixels based on the edge classification. Edge-based SAO filtering may include various configurations, where the value of a pixel may be compared to two of its eight neighboring pixels. Which two pixels are used for comparison may depend on which variation of edge-based offset is used. Based on the magnitude difference between the current pixel and the two neighbors, an offset may be applied to the pixel value.

When applying band offset filtering, pixels can be classified into different bands based on a pixel value, such as an intensity value, with each band having an associated offset. A band may include a range of pixel values. For example, pixel values ranging from 0 to 255 may be divided into 32 equal bands (labeled 0 to 31), such that pixel values 0-7 form a first band, pixel values 8-15 form a second band, and so on for all thirty-two bands. The bands can be used for determining which particular offset value to apply to a pixel or group of pixels. For example, if a pixel has a value of 10 (which is within the second band, i.e., values 8-15, in the example above), then an offset associated with the second band can be added to the pixel value. SAO parameters may include definitions of the bands, as well as values to be added to pixels in each of the bands. Such SAO parameters may be provided within an SAO parameter set, in accordance with the techniques of this disclosure.

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal compression. Intra-prediction unit 46 may alternatively perform intra-predictive coding of the received video block relative to one or more neighboring blocks in the same frame or slice as the block to be coded to provide spatial compression. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into LCUs, and partition each of the LCUs into sub-CUs based on rate-distortion analysis (e.g., rate-distortion optimization). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra or inter, e.g., based on error results, and provides the resulting intra- or inter-coded block to summer 50 to generate residual block data and to summer 62 to reconstruct the encoded block for use as a reference frame. Mode select unit 40 also provides syntax elements, such as motion vectors, intra-mode indicators, partition information, and other such syntax information, to entropy encoding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference frame memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference frame memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma components, and motion compensation unit 44 uses motion vectors calculated based on the luma components for both chroma components and luma components. Mode select unit 40 may also generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

After selecting an intra-prediction mode for a block, intra-prediction unit 46 may provide information indicative of the selected intra-prediction mode for the block to entropy encoding unit 56. Entropy encoding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20 forms a residual video block by subtracting the prediction data from mode select unit 40 from the original video block being coded. Summer 50 represents the component or components that perform this subtraction operation. Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used.

In any case, transform processing unit 52 applies the transform to the residual block, producing a block of residual transform coefficients. The transform may convert the residual information from a pixel value domain to a transform domain, such as a frequency domain. Transform processing unit 52 may send the resulting transform coefficients to quantization unit 54. Quantization unit 54 quantizes the transform coefficients to further reduce bit rate. The quantization process may reduce the bit depth associated with some or all of the coefficients. The quantization process may also be referred to as a “scaling” process, and thus, quantized transform coefficients may also be referred to as “scaled transform coefficients.” The degree of quantization (or scaling) may be modified by adjusting a quantization parameter. In some examples, quantization unit 54 may then perform a scan of the matrix including the quantized transform coefficients. Alternatively, entropy encoding unit 56 may perform the scan.

Quantization unit 54 may further use a quantization matrix table, representative of degrees of quantization to apply to pixels of blocks of transform coefficients. Quantization unit 54 may construct the quantization matrix table or select the quantization matrix table from a set of predefined quantization matrix tables. Entropy encoding unit 56 may form a quantization matrix table parameter set representative of the quantization matrix table used by quantization unit 54 to quantize a block of transform coefficients. For example, video encoder 20 may construct a quantization matrix table parameter set as discussed above with respect to Table 7. The same quantization matrix table parameter set may apply to all blocks of a slice of video data.

Following quantization, entropy encoding unit 56 entropy codes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference frame memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference frame memory 64. The reconstructed video block may be used by motion estimation unit 42 and motion compensation unit 44 as a reference block to inter-code a block in a subsequent video frame.

Mode select unit 40, or another unit of video encoder 20, may also construct a reference picture list construction parameter set, which may be coded by entropy encoding unit 56. For example, the reference picture list construction parameter set may correspond to the description of Table 8 above. The reference picture list construction parameter set may generally indicate how reference picture lists (e.g., List 0 and List 1) are to be constructed. Similarly, mode select unit 40, or another unit of video encoder 20, may construct a reference picture set parameter set, which may be coded by entropy encoding unit 56. The reference picture set parameter set may indicate how to form reference picture sets, from which reference picture lists may be constructed. The reference picture set parameter set may correspond to the description of Table 9 above.

Furthermore, video encoder 20 may construct one or more parameter set groups that each corresponds to one parameter set from each of a plurality of different types of parameter sets. For example, assuming that video encoder 20 codes parameter sets of types including video parameter sets, sequence parameter sets, picture parameter sets, adaptive loop filter parameter sets, sample adaptive offset parameter sets, quantization matrix table parameter sets, reference picture list construction parameter sets, and reference picture set parameter sets, video encoder 20 may further construct parameter set groups that each include one member from each of these types of parameter sets. Video encoder 20 may code a group parameter set, e.g., in accordance with either Table 3 or Table 10 above, that describes one or more parameter set groups, and includes identifier values for each of the parameter set groups.

For example, one parameter set group may correspond to one parameter set from the video parameter sets, one parameter set from the sequence parameter sets, one parameter set from the picture parameter sets, one parameter set from the adaptive loop filter parameter sets, one parameter set from the sample adaptive offset parameter sets, one parameter set from the quantization matrix table parameter sets, one parameter set from the reference picture list construction parameter sets, and one parameter set from the reference picture set parameter sets. A parameter set group need not include a parameter set from a particular type of parameter sets, if parameters of that type are not used to code a slice referring to the parameter set group.

Accordingly, video encoder 20 may code data representative of one or more parameter set groups. Furthermore, video encoder 20 may associate each of the parameter set groups with a parameter set group identifier (ID). When coding a slice of video data, video encoder 20 may code a value representative of the parameter set group ID in the slice, e.g., in a header of the slice. More particularly, the parameter set group ID may correspond to a parameter set group that identifies the parameter sets of each category that are used to code the corresponding slice of video data.

Furthermore, video encoder 20 may encapsulate the various coded parameter sets, as well as the data representing the parameter set groups (e.g., a group parameter set, as described above with respect to Table 3 and Table 10), into respective NAL units. Video encoder 20 may indicate that a NAL unit includes parameter set data using a particular NAL unit type. For example, there may be a dedicated NAL unit type indicating that the corresponding NAL unit includes parameter set data. In this example, video encoder 20 may further code parameter set type values for each parameter set to indicate a type to which the parameter set conforms, e.g., as discussed above with respect to Table 2. Alternatively, various NAL unit types may be determined for respective types of parameter sets, e.g., as described above with respect to Table 1.

In this manner, video encoder 20 of FIG. 2 represents an example of a video encoder configured to code a parameter set group representing a first parameter set of a first type and a second parameter set of a second, different type, and code a slice of video data using information of the parameter set group, information of the first parameter set, and information of the second parameter set, wherein the slice includes information referring to the parameter set group. Video encoder 20 may be further configured to code the first parameter set and the second parameter set.

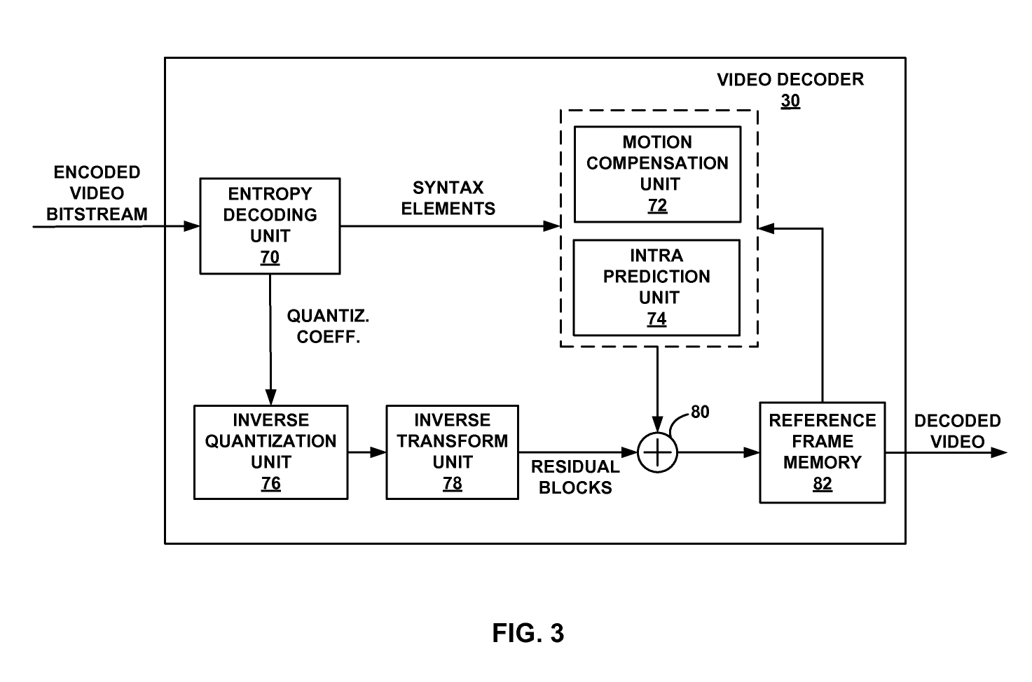

FIG. 3 is a block diagram illustrating an example of video decoder 30 that may implement techniques for utilizing signaling data in parameter set groups. In the example of FIG. 3, video decoder 30 includes an entropy decoding unit 70, motion compensation unit 72, intra prediction unit 74, inverse quantization unit 76, inverse transformation unit 78, reference frame memory 82 and summer 80. Video decoder 30 may, in some examples, perform a decoding pass generally reciprocal to the encoding pass described with respect to video encoder 20 (FIG. 2).

In accordance with the techniques of this disclosure, video decoder 30 may decode parameter sets of various types, as well as a group parameter set that includes identifiers for groups of parameter sets of different types. For example, video decoder 30 may decode the parameter sets, e.g., according to Tables 1-10 discussed above, and provide values indicative of the decoded parameter sets to other components of video decoder 30. The group parameter set may indicate a correspondence between a group identifier (ID) and one parameter set of each type, e.g., as discussed above with respect to Table 3 and Table 10. Video decoder 30 may also decode parameter sets of various types, as discussed in greater detail below. Furthermore, video decoder 30 may determine the type of parameter set using type data of the parameter set (e.g., as discussed above with respect to Table 2) and/or using NAL unit type data (e.g., as discussed above with respect to Table 1). Video decoder 30 may decode parameter sets and group parameter sets once for a bitstream or multiple times, e.g., following each random access point (RAP) or each instantaneous decoder refresh (IDR) picture.

After decoding parameter set and group parameter set data, video decoder 30 may decode video coding layer (VCL) NAL units of the bitstream. For example, video decoder 30 may receive data for a slice, including a group ID that corresponds to one parameter set of each of a plurality of different types. Video decoder 30 may decode data of the slice using the parameter sets indicated by the parameter set group corresponding to the group ID. Motion compensation unit 72 may generate prediction data based on motion vectors received from entropy decoding unit 70, while intra-prediction unit 74 may generate prediction data based on intra-prediction mode indicators received from entropy decoding unit 70.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors and other syntax elements to motion compensation unit 72. Video decoder 30 may receive the syntax elements at the video slice level and/or the video block level.

When the video slice is coded as an intra-coded (I) slice, intra prediction unit 74 may generate prediction data for a video block of the current video slice based on a signaled intra prediction mode and data from previously decoded blocks of the current frame or picture. When the video frame is coded as an inter-coded (i.e., B, P or GPB) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference frame lists, List 0 and List 1, using default construction techniques based on reference pictures stored in reference frame memory 82. Alternatively, video decoder 30 may use data of either or both of a reference picture list construction parameter set (e.g., in accordance with Table 8) and/or a reference picture set parameter set (e.g., in accordance with Table 9) to perform list construction and/or to determine reference picture sets.

Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Inverse quantization unit 76 inverse quantizes, i.e., de-quantizes, the quantized transform coefficients provided in the bitstream and decoded by entropy decoding unit 70. The inverse quantization process may include use of a quantization parameter QP_{Y} calculated by video decoder 30 for each video block in the video slice to determine a degree of quantization and, likewise, a degree of inverse quantization that should be applied. The inverse quantization process may utilize a quantization matrix table. For example, video decoder 30 may decode a quantization matrix table parameter set, e.g., in accordance with Table 7.

Inverse transform unit 78 applies an inverse transform, e.g., an inverse DCT, an inverse integer transform, or a conceptually similar inverse transform process, to the transform coefficients in order to produce residual blocks in the pixel domain.

After motion compensation unit 72 generates the predictive block for the current video block based on the motion vectors and other syntax elements, video decoder 30 forms a decoded video block by summing the residual blocks from inverse transform unit 78 with the corresponding predictive blocks generated by motion compensation unit 72. Summer 80 represents the component or components that perform this summation operation. If desired, a deblocking filter may also be applied to filter the decoded blocks in order to remove blockiness artifacts. For example, the filter may filter the output of summer 80. The filter may utilize adaptive loop filter (ALF) parameters signaled in an ALF parameter set, e.g., in accordance with Table 5. Additionally or alternatively, the filter may perform sample adaptive offset (SAO) techniques using SAO parameters, e.g., in accordance with Table 6. Other loop filters (either in the coding loop or after the coding loop) may also be used to smooth pixel transitions, or otherwise improve the video quality. The decoded video blocks in a given frame or picture are then stored in reference picture memory 82, which stores reference pictures used for subsequent motion compensation. Reference frame memory 82 also stores decoded video for later presentation on a display device, such as display device 32 of FIG. 1.

In this manner, video decoder 30 of FIG. 3 represents an example of a video decoder configured to code a parameter set group representing a first parameter set of a first type and a second parameter set of a second, different type, and code a slice of video data using information of the parameter set group, information of the first parameter set, and information of the second parameter set, wherein the slice includes information referring to the parameter set group. Video decoder 30 may be further configured to code the first parameter set and the second parameter set.

FIG. 4 is a conceptual diagram illustrating an example parameter set grouping consistent with one or more examples of this disclosure. In this example, parameter set data 100 includes Type-A parameter sets 102, Type-B parameter sets 104, Type-C parameter sets 106, and parameter set groups 108. Parameter sets of a given type (e.g., “Type-X”) are represented as “X parameter set” or “XPS” in FIG. 4. Thus, Type-A parameter sets 102 include APSs 110A-110C, Type-B parameter sets 104 include BPSs 112A-112C, and Type-C parameter sets 106 include CPSs 114A-114B. In this example, various parameter sets may have parameter set types (e.g., Type-A, Type-B, and Type-C) to indicate data included in the parameter sets. The example of FIG. 4 illustrates parameter sets of different types having different parameter set type IDs.

Furthermore, parameter set groups 108 includes groups 116A-116D that correspond to one parameter set from each of Type-A parameter sets 102, Type-B parameter sets 104, and Type-C parameter sets 106. In particular, in this example, group 116A corresponds to APS 110A, BPS 112A, and CPS 114A; group 116B corresponds to APS 110B, BPS 112B, and CPS 114A; group 116C corresponds to APS 110B, BPS 112C, and CPS 114B; and group 116D corresponds to APS 110C, BPS 112C, and CPS 114B. Accordingly, each of the types IDs may correspond to a respective group ID.

As discussed below with respect to FIG. 5, a slice may include information that refers to a group ID, and the group ID may correspond to a parameter set of each type. In this manner, a slice may simply indicate a value of a parameter set group ID, in order to represent a combination of parameter sets of various types. For example, a slice specifying a group ID associated with group 116A may be coded using data of APS 110A, BPS 112A, and CPS 114A. Likewise, a slice specifying a group ID associated with group 116B may be coded using data of APS 110B, BPS 112B, and CPS 114A.

FIG. 5 is a conceptual diagram illustrating slice headers that refer to different parameter set group IDs. In this example, slices 120 include slices 128, 138, 148. Slice 128 includes slice header 122 and slice body 126; slice 138 includes slice header 132 and slice body 136; and slice 148 includes slice header 142 and slice body 146.

Moreover, in this example, slice header 122 includes data specifying group ID 124, corresponding to group 116A. Thus, video data of slice body 126 may be coded using parameters of APS 110A, BPS 112A, and CPS 114A. Slice header 132 includes data specifying group ID 134, corresponding to group 116B. Thus, video data of slice body 136 may be coded using parameters of APS 110B, BPS 112B, and CPS 114A. Similarly, slice header 142 includes data specifying group ID 144, corresponding to group 116D. Thus, video data of slice body 146 may be coded using parameters of APS 110C, BPS 112C, and CPS 114B.

In this manner, slice headers may include information indicating a group ID, and the group ID may correspond to one of each of a plurality of different parameter sets. Therefore, rather than specifying ID values for each of Type-A parameter sets, Type-B parameter sets, and Type-C parameter sets, a slice may include information that simply refers to a group ID, and the group ID may be mapped to ID values for parameter sets of each of Type-A parameter sets, Type-B parameter sets, and Type-C parameter sets.

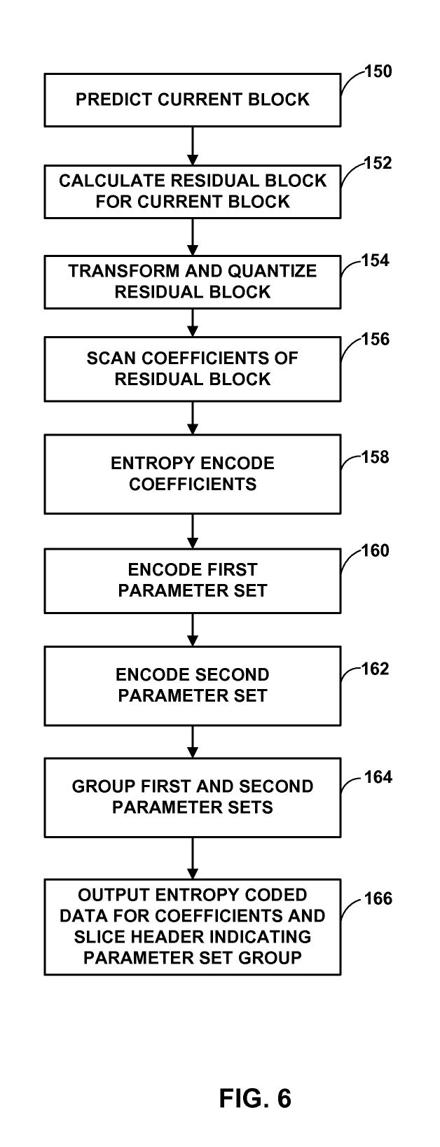

FIG. 6 is a flowchart illustrating an example method for encoding a current block of video data using data signaled by a parameter set group. The current block may comprise a current CU or a portion of the current CU. Although described with respect to video encoder 20 (FIGS. 1 and 2), it should be understood that other devices may be configured to perform a method similar to that of FIG. 6. Moreover, the method of FIG. 6 generally describes coding of a block of video data, where the block is included in a slice. Coding of the block generally includes coding the block according to parameters specified for the slice in which the block is included. In accordance with the techniques of this disclosure, the parameters may be specified in two or more different types of parameter sets, e.g., a first parameter set and a second parameter set.

In this example, video encoder 20 initially predicts the current block (150). For example, video encoder 20 may calculate one or more prediction units (PUs) for the current block. Video encoder 20 may then calculate a residual block for the current block, e.g., to produce a transform unit (TU) (152). To calculate the residual block, video encoder 20 may calculate a difference between the original, uncoded block and the predicted block for the current block. Video encoder 20 may then transform and quantize coefficients of the residual block (154). As noted above, the parameter set group may include data specifying syntax, such as a quantization matrix, for the block, that may be used during quantization. Next, video encoder 20 may scan the quantized transform coefficients of the residual block (156). During the scan, or following the scan, video encoder 20 may entropy encode the coefficients (158). For example, video encoder 20 may encode the coefficients using CAVLC or CABAC.

Video encoder 20 may also encode the first parameter set (160) and the second parameter set (162). Although shown as occurring after encoding the block, it should be understood that coding the first and second parameter sets may alternatively be performed prior to coding the block. For example, video encoder 20 may encode a plurality of parameter sets, as well as one or more parameter set groups, prior to coding video data (e.g., the block), and then code the block according to parameter sets indicated by a parameter set group corresponding to a group ID coded in a slice including the block.

The first and second parameter sets may be of different types, e.g., as indicated by NAL unit types for NAL units including the parameter sets, or as indicated by parameter set type values included in the parameter sets, e.g., following headers for the NAL units. For example, if the parameter sets are adaptation parameter sets, the parameter set types may indicate that the adaptation sets are one of adaptive loop filter (ALF) adaptation parameter sets, sample adaptive offset (SAO) adaptation parameter sets, quantization matrix adaptation parameter sets, or reference picture set adaptation parameter sets. Thus, the same NAL unit type may be used to specify that a NAL unit includes a parameter set, whether a picture parameter set, a sequence parameter set, an adaptation parameter set, or other parameter set, and the NAL unit may include data (e.g., following the NAL unit header) indicative of a type for the parameter set.

Furthermore, in accordance with the techniques of this disclosure, video encoder 20 may group the first and second (and any additional) parameter sets (164) into a parameter set group, e.g., as shown in and described with respect to FIG. 4. Video encoder 20 may then output the entropy coded data of the block, as well as a slice header for a slice including the block that indicates the parameter set group (166). For example, the slice header may include a group ID value that identifies a group including parameter sets including information used to code the slice including the block, e.g., the first parameter set and the second parameter set.

In this manner, the method of FIG. 6 represents an example of a method including coding a first parameter set of a first type, coding a second parameter set of a second, different type, grouping the first parameter set and the second parameter set into a parameter set group, and coding a slice of video data using information of the parameter set group, wherein the slice includes information referring to the parameter set group. The method of FIG. 6 also represents an example of a method including coding a parameter set group representing a first parameter set of a first type and a second parameter set of a second, different type, and coding a slice of video data using information of the parameter set group, information of the first parameter set, and information of the second parameter set, wherein the slice includes information referring to the parameter set group.

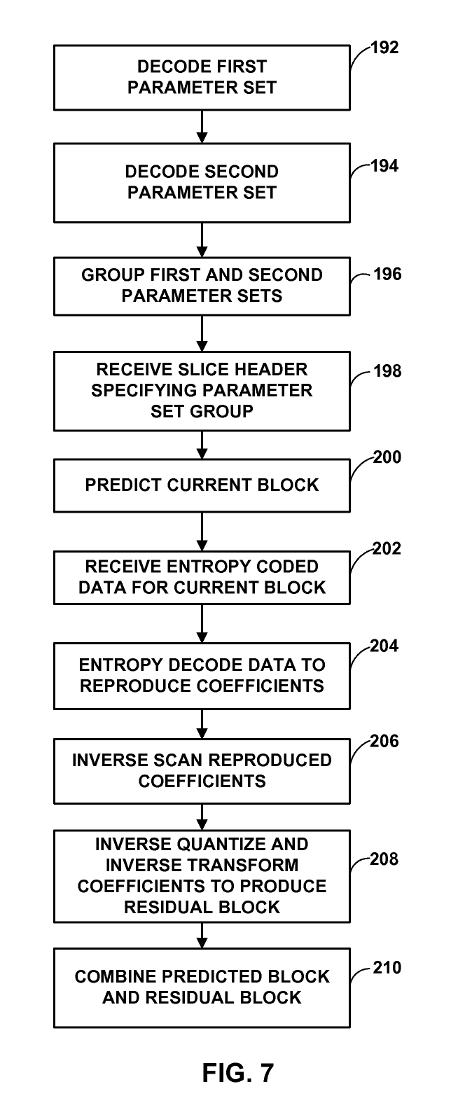

FIG. 7 is a flowchart illustrating an example method for decoding a current block of video data using data signaled by a parameter set group. The current block may comprise a current CU or a portion of the current CU. Although described with respect to video decoder 30 (FIGS. 1 and 3), it should be understood that other devices may be configured to perform a method similar to that of FIG. 7. Moreover, the method of FIG. 7 generally describes coding of a block of video data, where the block is included in a slice. Coding of the block generally includes coding the block according to parameters specified for the slice in which the block is included. In accordance with the techniques of this disclosure, the parameters may be specified in two or more different types of parameter sets, e.g., a first parameter set and a second parameter set.

Accordingly, video decoder 30 may decode a first parameter set (192) and decode a second parameter set (194). The first and second parameter sets may be of different types, e.g., as indicated by NAL unit types for NAL units including the parameter sets, or as indicated by parameter set type values included in the parameter sets, e.g., following headers for the NAL units. For example, if the parameter sets are adaptation parameter sets, the parameter set types may indicate that the adaptation sets are one of adaptive loop filter (ALF) adaptation parameter sets, sample adaptive offset (SAO) adaptation parameter sets, quantization matrix adaptation parameter sets, or reference picture set adaptation parameter sets. Thus, the same NAL unit type may be used to specify that a NAL unit includes a parameter set, whether a picture parameter set, a sequence parameter set, an adaptation parameter set, or other parameter set, and the NAL unit may include data (e.g., following the NAL unit header) indicative of a type for the parameter set.

Moreover, video decoder 30 may use data representative of a type for the parameter set to determine information included in the parameter set, which may determine a syntax table, context free grammar, parsing tree, or other construct for properly interpreting the parameter set. As noted above, the data representative of the type for the parameter set may be a NAL unit type for the NAL unit including the parameter set, or a parameter set type value included in the NAL unit, e.g., following the NAL unit header.

Video decoder 30 may also group the first and second parameter sets (196). Moreover, video decoder 30 may receive a slice header including information that specifies the parameter set group (198). Of course, as discussed above, the parameter set group may include additional types of parameter sets. In general, there may be any number of parameter sets for a parameter set group, where zero or one type of parameter set may be selected from among each available type of parameter set.

Video decoder 30 may then predict the current block (200), e.g., using an intra- or inter-prediction mode to calculate a predicted block for the current block. Video decoder 30 may also receive entropy coded data for the current block, such as entropy coded data for coefficients of a residual block corresponding to the current block (202). Video decoder 30 may entropy decode the entropy coded data to reproduce coefficients of the residual block (204). Video decoder 30 may then inverse scan the reproduced coefficients (206), to create a block of quantized transform coefficients. Video decoder 30 may then inverse quantize and inverse transform the coefficients to produce a residual block (208). Video decoder 30 may ultimately decode the current block by combining the predicted block and the residual block (210).

In this manner, the method of FIG. 7 represents an example of a method including coding a first parameter set of a first type, coding a second parameter set of a second, different type, grouping the first parameter set and the second parameter set into a parameter set group, and coding a slice of video data using information of the parameter set group, wherein the slice includes information referring to the parameter set group. The method of FIG. 7 also represents an example of a method including coding a parameter set group representing a first parameter set of a first type and a second parameter set of a second, different type, and coding a slice of video data using information of the parameter set group, information of the first parameter set, and information of the second parameter set, wherein the slice includes information referring to the parameter set group.

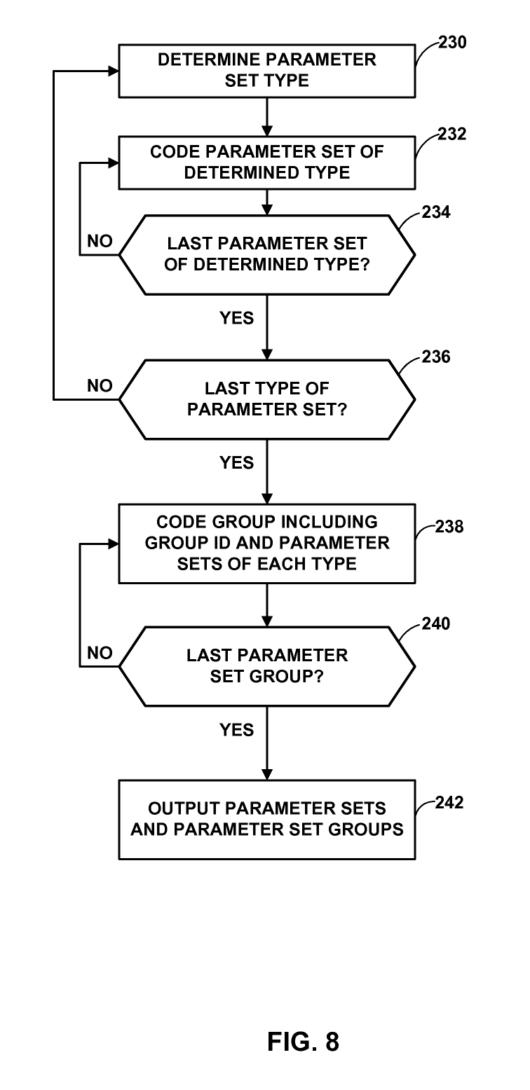

FIG. 8 is a flowchart illustrating an example method for coding parameter sets of a variety of different types and parameter set groups indicating parameter sets of each type. The method of FIG. 8 may generally be performed prior to coding video data using parameters of the parameter sets. In this example, video encoder 20 may initially determine a parameter set type (230), e.g., a first parameter set type. For example, the first parameter set type may correspond to a sequence parameter set (SPS). In addition, video encoder 20 may code a type identifier for the determined type of parameter set, e.g., in accordance with either or both of Tables 1 and 2, as described above. That is, video encoder 20 may code a NAL unit type representative of the type of parameter set, and/or code a parameter set type value for the type of parameter set. Video encoder 20 may further encode a parameter set of the determined type (232), e.g., a first SPS. Video encoder 20 may then determine whether the most recently coded parameter set is the last parameter set of the determined type (234). If the parameter set is not the last parameter set of the determined type (“NO” branch of 234), video encoder 20 may code a subsequent parameter set of the determined type (232), e.g., a subsequent SPS.

On the other hand, if the parameter set is the last parameter set of the determined type (“YES” branch of 234), video encoder 20 may further determine whether the last type of parameter set has been reached (236). If the last type of parameter set has not been reached, video encoder 20 may repeat steps 230-234 for each type of parameter set, e.g., for types of parameter sets including SPSs, PPSs, ALF parameter sets, SAO parameter sets, quantization matrix table parameter sets, reference picture list construction parameter sets, and reference picture set parameter sets.

After the last type of parameter set has been coded (“YES” branch of 236), video encoder 20 may code a group including a group ID and parameter sets of each type (238). For example, video encoder 20 may code a group parameter set in accordance with Table 3 and Table 10, as discussed above. That is, video encoder 20 may code data indicating that the group ID of the current parameter set group is associated with a particular parameter set of each type. For example, the group ID may be associated with a particular SPS, PPS, ALF parameter set, SAO parameter set, quantization matrix table parameter set, reference picture list construction parameter set, and reference picture set parameter set.

Furthermore, video encoder 20 may determine whether the last parameter set group has been coded (240). If the last parameter set group has not been formed (“NO” branch of 240), video encoder 20 may form a subsequent group in accordance with step 238. After the last parameter set group has been formed (“YES” branch of 240), video encoder 20 may output the coded parameter sets and the parameter set groups.

Video decoder 30 may perform a generally reciprocal method to the method of FIG. 8. That is, video decoder 30 may decode parameter sets of a variety of different types, and decode parameter set groups including group IDs and parameter sets of each type associated with the group ID. Thus, although FIG. 8 is described from the perspective of video encoding, similar reciprocal techniques may be applied in a decoding process.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding video data, the method comprising:
coding a parameter set group representing a first parameter set of a first type and a second parameter set of a second, different type; and
coding a slice of video data using information of the parameter set group, information of the first parameter set, and information of the second parameter set, wherein the slice includes information referring to the parameter set group.

2. The method of claim 1, further comprising coding data that signals an identifier of at least one of the first type of the first parameter set and the second type of the second parameter set.

3. The method of claim 1, wherein the information referring to the parameter set group comprises a parameter set group identifier.

4. The method of claim 1, wherein the first type and the second type are each selected from a group of parameter set types including an adaptive loop filter parameter set, a sample adaptive offset parameter set, a quantization matrix table parameter set, a reference picture list construction parameter set, and a reference picture set parameter set.

5. The method of claim 1, further comprising:
coding the first parameter set; and
coding the second parameter set.

6. The method of claim 5,
wherein coding the first parameter set comprises coding a first network abstraction layer (NAL) unit comprising the first parameter set; and
wherein coding the second parameter set comprises coding a second NAL unit, different from the first NAL unit, comprising the second parameter set.

7. The method of claim 6, wherein coding the parameter set group comprises coding a third NAL unit, different from the first NAL unit and the second NAL unit, comprising the parameter set group.

8. The method of claim 5, wherein coding the slice comprises identifying the parameter set group and decoding the slice, wherein coding the first parameter set comprises decoding the first parameter set and a first identifier of the first parameter set, and wherein coding the second parameter set comprises decoding the second parameter set and a second identifier of the second parameter set.

9. The method of claim 5,
wherein coding the first parameter set comprises coding a first parameter set type value representative of the first type, and
wherein coding the second parameter set comprises coding a second, different parameter set type value representative of the second type.

10. The method of claim 9,
wherein coding the first parameter set comprises coding a first adaptation parameter set including only information conforming to the first type, and
wherein coding the second parameter set comprises coding a second adaptation parameter set including only information conforming to the second type.

11. The method of claim 1, further comprising:
coding a first network abstraction layer (NAL) unit type for a first NAL unit encapsulating the first parameter set, wherein the first NAL unit type is representative of the first type for the first parameter set; and
coding a second, different NAL unit type for a second NAL unit encapsulating the second parameter set, wherein the second NAL unit type is representative of the second type for the second parameter set.

12. The method of claim 11, further comprising:
determining a correspondence between the first type and the first NAL unit type according to data that defines an order for parameter set types, wherein the data represents parameter set types using respective offset values from a predetermined NAL unit type value according to the defined order; and
determining a correspondence between the second type and the second NAL unit type according to the data that defines the order for the parameter set types.

13. The method of claim 1, wherein coding the parameter set group comprises coding a plurality of parameter set groups, wherein each of the parameter set groups refers to a respective set of one or more parameter sets of different types.

14. A device for coding video data, the device comprising a video coder configured to code a parameter set group representing a first parameter set of a first type and a second parameter set of a second, different type, and code a slice of video data using information of the parameter set group, information of the first parameter set, and information of the second parameter set, wherein the slice includes information referring to the parameter set group.

15. The device of claim 14, wherein the first type and the second type are each selected from a group of parameter set types including an adaptive loop filter parameter set, a sample adaptive offset parameter set, a quantization matrix table parameter set, a reference picture list construction parameter set, and a reference picture set parameter set.

16. The device of claim 14, wherein the video coder is further configured to code the first parameter set and code the second parameter set.

17. The device of claim 16, wherein the device is further configured to code a first network abstraction layer (NAL) unit comprising the first parameter set, code a second NAL unit, different from the first NAL unit, comprising the second parameter set, and code a third NAL unit, different from the first NAL unit and the second NAL unit, comprising the parameter set group.

18. The device of claim 16, wherein the video coder is further configured to code a first parameter set type value representative of the first type, and code a second, different parameter set type value representative of the second type.

19. The device of claim 14, wherein the video coder comprises a video decoder.

20. The device of claim 14, wherein the video coder comprises a video encoder.

21. A device for coding video data, the device comprising:
means for coding a parameter set group representing a first parameter set of a first type and a second parameter set of a second, different type; and
means for coding a slice of video data using information of the parameter set group, information of the first parameter set, and information of the second parameter set, wherein the slice includes information referring to the parameter set group.

22. The device of claim 21, wherein the first type and the second type are each selected from a group of parameter set types including an adaptive loop filter parameter set, a sample adaptive offset parameter set, a quantization matrix table parameter set, a reference picture list construction parameter set, and a reference picture set parameter set.

23. The device of claim 21, further comprising:
means for coding the first parameter set; and
means for coding the second parameter set.

24. The device of claim 23,
wherein the means for coding the first parameter set comprises means for coding a first network abstraction layer (NAL) unit comprising the first parameter set;
wherein the means for coding the second parameter set comprises means for coding a second NAL unit, different from the first NAL unit, comprising the second parameter set; and
wherein the means for coding the parameter set group comprises means for coding a third NAL unit, different from the first NAL unit and the second NAL unit, comprising the parameter set group.

25. The device of claim 23,
wherein the means for coding the first parameter set comprises means for coding a first parameter set type value representative of the first type, and
wherein the means for coding the second parameter set comprises means for coding a second, different parameter set type value representative of the second type.

26. A computer-readable storage medium having stored thereon instructions that, when executed, cause a processor of a device for coding video data to
code a parameter set group representing a first parameter set of a first type and a second parameter set of a second, different type; and
code a slice of video data using information of the parameter set group, information of the first parameter set, and information of the second parameter set, wherein the slice includes information referring to the parameter set group.

27. The computer-readable storage medium of claim 26, wherein the first type and the second type are each selected from a group of parameter set types including an adaptive loop filter parameter set, a sample adaptive offset parameter set, a quantization matrix table parameter set, a reference picture list construction parameter set, and a reference picture set parameter set.

28. The computer-readable storage medium of claim 26, further comprising instructions that cause the processor to:
code the first parameter set; and
code the second parameter set.

29. The computer-readable storage medium of claim 28,
wherein the instructions that cause the processor to code the first parameter set comprise instructions that cause the processor to code a first network abstraction layer (NAL) unit comprising the first parameter set,
wherein the instructions that cause the processor to code the second parameter set comprise instructions that cause the processor to code a second NAL unit, different from the first NAL unit, comprising the second parameter set, and
wherein the instructions that cause the processor to code the parameter set group comprise instructions that cause the processor to code a third NAL unit, different from the first NAL unit and the second NAL unit, comprising the parameter set group.

30. The computer-readable storage medium of claim 28,
wherein the instructions that cause the processor to code the first parameter set comprise instructions that cause the processor to code a first parameter set type value representative of the first type, and
wherein the instructions that cause the processor to code the second parameter set comprise instructions that cause the processor to code a second, different parameter set type value representative of the second type.
